(19) United States
(12) Patent Application Publication
(10) Pub. No.: US 2006/0228690 A1
(43) Pub. Date: Oct. 12, 2006

(54) Smart buttons: training tracker and motivator

(75) Inventor: Arnold Lund, Sammimish, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/102,474

(22) Filed: Apr. 8, 2005

(51) Int. Cl. G09B 7/00

(52) U.S. Cl. 434/362

(57) ABSTRACT

The invention relates to systems and methods for tracking training and motivating a user to learn aspects of installed software or hardware. Aspects of the invention relate to methods that guide indications of a user's knowledge of a function or element of installed hardware or software on a user computer. Further aspects of the invention relate to motivating a user to learn underutilized features of a user computer. Yet further aspects of the invention relate to a display that changes based on a user's current state of knowledge in relation to a particular function or element of a software program. In one embodiment, the display output may be independent of the state of the software or hardware.

### FIELD OF THE INVENTION

The invention relates to training modules in the computer-related industries. More specifically, aspects of the invention relate to systems and methods for tracking training and motivating a user to learn aspects of installed software or hardware.

### BACKGROUND OF THE INVENTION

Advances in hardware and software technology have increased functionality of computers. As a result, however, application software has become increasingly complex. Indeed, a large portion of recent technological advances have built more complex functions into existing applications. Thus, while computer applications have continued to increase in functionality, they have also greatly increased in complexity for the user. Furthermore, users may not even be aware of recently developed features. This is especially true, for example, when new features are added to already existing software. Indeed, as more and more programs are updated automatically through the internet, users are less likely to be aware of new features. Furthermore, without adequate training, newer functions may never be utilized by the end-user.

Research demonstrates users find more value in products upon receiving proper training. Traditionally, printed manuals are distributed with software or hardware of a user computer. As mentioned above, however, updates are increasingly being downloaded online and therefore may not accompany an updated manual. Furthermore, manuals are generally consulted for troubleshooting a feature a user is already familiar with. Similarly, a user may not be aware of newly acquired features upon installing new hardware.

More recently, there have been interactive approaches such as multimedia presentations that more readily inform a user of available features. Again, this approach is limited by the fact that the majority of users do not view the entire presentation, and therefore do not learn valuable features of the software. It goes from the foregoing, therefore, there exists a need in the computing industry for systems and methods for increasing a user's knowledge of their mastery of a software application or installed hardware and for systems and methods to motivate or train a user to learn underutilized or poorly understood features.

### SUMMARY OF THE INVENTION

Aspects of the invention relate to methods that guide indications of a user's knowledge of a function or element of hardware or software on a user computer. Further aspects of the invention relate to motivating a user to learn underutilized features of a user computer. Yet further aspects of the invention relate to a display that changes based on a user's current state of knowledge in relation to a particular function or element of a software program. In one embodiment, the display output is independent of the state of the software or hardware.

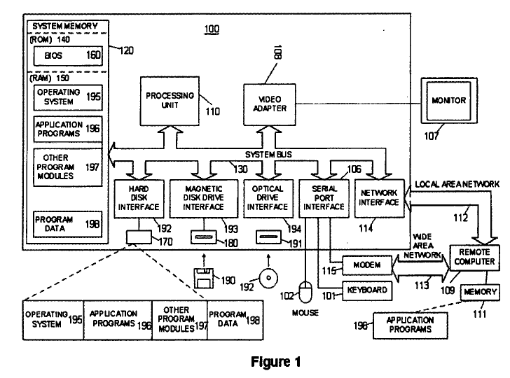

FIG. 1 illustrates an exemplary computer system in which embodiments of the invention may be implemented.

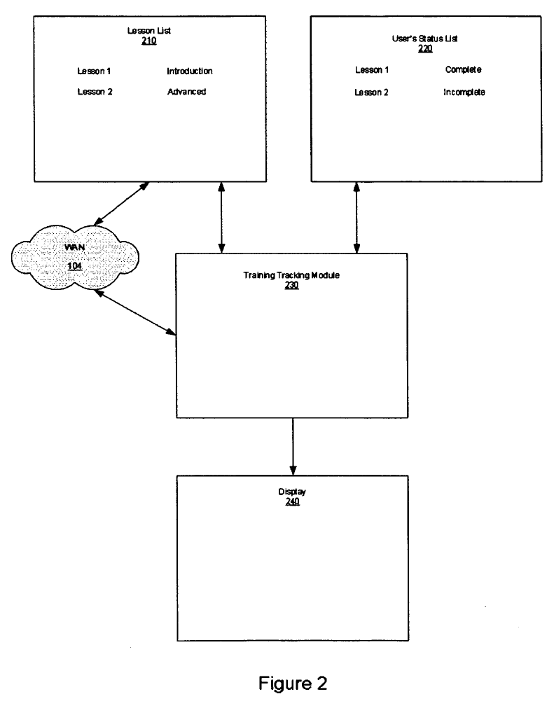

FIG. 2 illustrates a schematic diagram of an exemplary embodiment of the present invention.

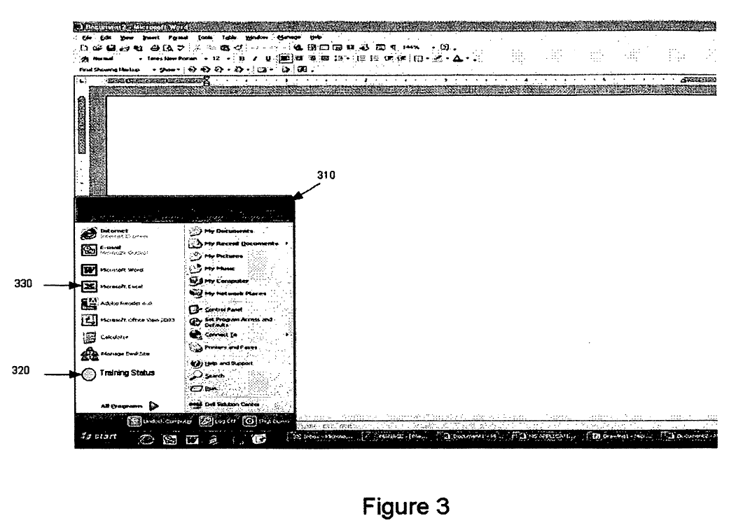

FIG. 3 illustrates one embodiment of the invention having a display comprising at least one icon.

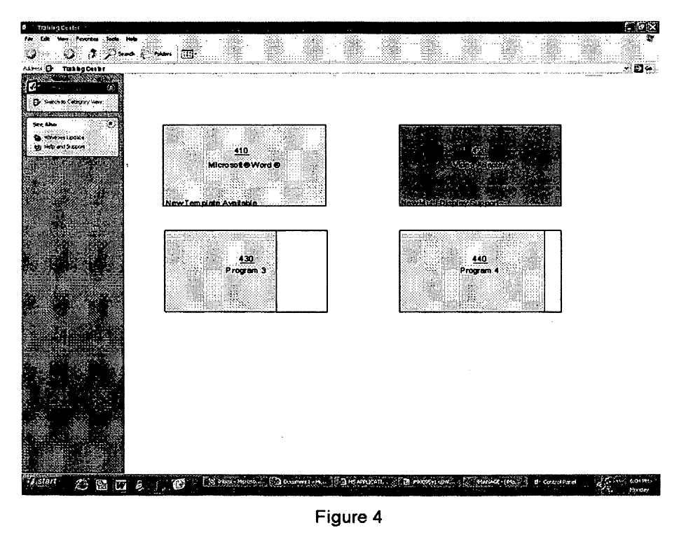

FIG. 4 illustrates at least one embodiment of the present invention having an interactive icon to provide additional information.

### DETAILED DESCRIPTION OF THE INVENTION

Exemplary Operating Environment

FIG. 1 is a functional block diagram of an example of a conventional general-purpose digital computing environment that can be used in connection with selecting parameter value combinations to use when testing software modules. In FIG. 1, a computer 100 includes a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150.

A basic input/output system 160 (BIOS), containing the basic routines that help to transfer information between elements within the computer 100, such as during start-up, is stored in the ROM 140. The computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192 such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules and other data for the personal computer 100. It will be appreciated by those skilled in the art that other types of computer readable media that can store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules can be stored on the hard disk drive 170, magnetic disk 190, optical disk 192, ROM 140 or RAM 150, including an operating system 195, one or more application programs 196, other program modules 197, and program data 198. A user can enter commands and information into the computer 100 through input devices such as a keyboard 101 and pointing device 102. Other input devices (not shown) may include a microphone, joystick, game pad, satellite dish, scanner or the like. These and other input devices are often connected to the processing unit 110 through a serial port interface 106 that is coupled to the system bus, but may be connected by other interfaces, such as a parallel port, game port or a universal serial bus (USB). Further still, these devices may be coupled directly to the system bus 130 via an appropriate interface (not shown). A monitor 107 or other type of display device is also connected to the system bus 130 via an interface, such as a video adapter 108. In addition to the monitor, personal computers typically include other peripheral output devices (not shown), such as speakers and printers.

The computer 100 can operate in a networked environment using logical connections to one or more remote computers, such as a remote computer 109. The remote computer 109 can be a server, a router, a network PC, a peer device or other common network node, and typically includes many or all of the elements described above relative to the computer 100, although only a memory storage device 111 has been illustrated in FIG. 1. The logical connections depicted in FIG. 1 include a local area network (LAN) 112 and a wide area network (WAN) 113. Such networking environments are commonplace in offices, enterprise-wide computer networks, intranets and the Internet.

When used in a LAN networking environment, the computer 100 is connected to the local network 112 through a network interface or adapter 114. When used in a WAN networking environment, the personal computer 100 typically includes a modem 115 or other means for establishing a communications over the wide area network 113, such as the Internet. The modem 115, which may be internal or external, is connected to the system bus 130 via the serial port interface 106. In a networked environment, program modules depicted relative to the personal computer 100, or portions thereof, may be stored in the remote memory storage device.

It will be appreciated that the network connections shown are illustrative and other techniques for establishing a communications link between the computers can be used. The existence of any of various well-known protocols such as TCP/IP, Ethernet, FTP, HTTP, Bluetooth, IEEE 802.11x and the like is presumed, and the system can be operated in a client-server configuration to permit a user to retrieve web pages from a web-based server. Any of various conventional web browsers can be used to display and manipulate data on web pages.

### DESCRIPTION OF ILLUSTRATIVE EMBODIMENTS

FIG. 2 illustrates a schematic diagram of one exemplary embodiment of the present invention. The embodiment illustrates one method or system that may be utilized to inform a user of underutilized features and motivate the user to learn how to use features of a user computer application. As used herein, the term “lesson” may comprise a multimedia presentation, a simple text script, or any indica to the user that increases the user's knowledge of a particular software or hardware. In the exemplary embodiment, a lesson list 210 comprises lessons available to the user. The lessons may provide an overview of installed software and be arranged in increasing difficulty. In other embodiments, the lessons may each concern different features of the same software. In yet further embodiments, the lessons comprise information about different programs or installed hardware. The lesson list 210 may be generated automatically by third-party software or within the operating system. Indeed, while a single lesson list is shown, it is contemplated by the current invention to have multiple lessons lists or to combine individual lesson lists from individual software and hardware packages into a single lesson list. The lesson list 210 may be configured to access the internet, for example, through the wide area network 104, therefore lessons may be added or updated as new features are downloaded or otherwise available on the computer. In yet further embodiments, the user may customize the lists to be downloaded.

The illustrated embodiment further comprises a user status list 220 comprising information relating to the user's completion of lessons within the lesson list 210. As illustrated by lesson list 220, the lesson list may provide information regarding if a user has successfully completed a particular lesson. In yet further embodiments, the status list 220 is automatically updated if the user's actions demonstrate proficiency in the subject matter of a particular lesson. For example, if lesson 1 of the lesson list 210 comprises introductory information concerning utilizing a word processing software, for example, Microsoft® Word®, a user's actions demonstrating proficiency in basic word processing features would update the user status list 220 to reflect lesson 1 has been completed or otherwise reflect that the user has demonstrated mastery of the subject matter of the lesson. In yet further embodiments, lessons could be prioritized by the users proficiency. While the lesson list 210 and the user status list 220 are illustrated as two individual lists, it is contemplated by the present invention to have a single list comprising both a lesson list and a user status list. Alternatively, multiple user status lists 220 comprising information lesson lists from individual software and hardware packages are also contemplated.

A training tracking module 230 sends and receives information from the lesson list 210 and the user status list 220. The tracking module may be loaded into the system memory 120 and process information with the processing unit 110. The tracking module 230 processes the received information from the lesson list 210 and the user status list 220 to provide an output on a display 240 (FIGS. 3 and 4 provide more illustrative embodiments of a display output). In at least one embodiment, the output on display 240 is independent from the state of the program the lesson is directed towards. For example, if the lessons relate to setting up an email account in, for example, Microsoft® Outlook®, an indicia of the user's knowledge may be displayed on display 240 regardless of whether Outlook® is active.

A multitude of algorithms may be utilized to determine how the information is processed in the tracking module 230. Additionally, the processing and displaying of the output may further depend on which software or hardware application the information is received from. Parameters that may contribute to the final output on display 240 include the number of lessons the user has actually completed, the number of features utilized by the user compared with the total number of available features, and the number of features the user has used with minimal exposure.

In yet further embodiments, the elapsed time a user has utilized a specific feature or program may be combined with additional parameters to determine the user's mastery of the subject matter. In one embodiment, the tracking module 230 may determine a lesson as completed upon the usage of a particular feature or features for a fixed amount of time that correspond to a particular lesson. For example, if the lesson list 210 comprises lessons relating to word processing, for example, Microsoft® Word®, the usage of the software for fixed period of time for word processing will result in the tracking module 230 updating the user status list 220. In yet further embodiments, the elapsed time a user has consistently utilized a particular feature is compared with a fixed time period representing the expected full beginning-to-end scenario to determine if the user has mastered the feature.

While the above description provides exemplary steps that may determine if a user has mastered a feature, those skilled in the art will appreciate the many methods and steps that may determine a user's completion and/or mastery of a given feature of software or hardware. Upon determining the user's knowledge, the tracking module 230 may continually update the user status list 220 and the output displayed on display 240. Furthermore, in at least one embodiment the tracking module 230 is configured to access the wide area network 104, therefore additional algorithms or rules may be downloaded.

FIG. 3 illustrates one embodiment of the invention, where the output on display 240 comprises at least one icon. In one embodiment, an icon is located in the start menu 310 of an operating system, for example, Microsoft® Windows®. A start menu icon 320 possesses attributes that may be altered based on the user's knowledge. Additionally, more than one attribute may be altered to inform or motivate a user to learn a feature or set of features. For example, the start menu icon 320 may change color indicating the user's level of training. For example, a green coloration may indicate the user is at an expected level of knowledge, whereas yellow indicates more training is warranted, and a red coloration may indicate more training is critical. This is especially advantageous in the industrial setting, where employers want to ensure their employees are at a specified level of learning. In one embodiment, a specific attribute may indicate specific features are locked until the user demonstrates proficiency for a given set of features or takes a lesson.

While the exemplary embodiment uses shades of a color as the icon attribute being altered, other icon attributes that may be altered include size and shape, or the combination of both size and shape. In yet further embodiments, a sound may be associated with a level of training, providing an audio cue to indicate more training is needed. One skilled in the art will recognize there are a large number of attributes of an icon that may be altered, such as, for example, animation of the icon.

The start menu icon 320 may be independent or used in conjunction with individual program icons, such as program icon 330. In one embodiment, the start menu icon 320 will be altered based upon the user's status on a plurality of individual programs, whereas program icon 330 will be altered to provide training information specific to a particular application. This is particularly useful when a new feature has been added to a particular program without the user's knowledge. For example, software and hardware developers increasingly encourage users to automatically update their hardware or software through the internet. When updating a computer, new features may be added without the user's knowledge, therefore the user is not aware of the need for further training. In the exemplary embodiment, one attribute of program icon 330 is altered to inform the user a new feature has been downloaded for Microsoft® Excel®. In yet further embodiments, different attributes of the program icon 330 may be simultaneously altered to further indicate the user's status of different features or elements. Attributes of both the start menu icon 320 and the program icon 330 may be updated or altered regardless of whether the user has the current program open or otherwise active in the system memory. In yet further embodiments, a plurality of program icons may be used without a start menu icon.

In yet still further embodiments, at least one tray icon 340 is present. The tray icon 330 may be loaded into a memory, such as the system memory 120, upon the starting the computer's operating system. The tray icon 330 attributes may be continually displayed on the system tray 350, thereby providing real-time training information to the user. In select embodiments, the start menu icon 320, program icon 330, and tray icon 340 may be interactive. For example, if a user browses over the individual icons 320, 330, 340, more detailed information may be displayed. In yet other embodiments, the user may “select” the icon, for example, by clicking on the icon, to open a new window or program to provide more detailed information.

FIG. 4 illustrates at least one embodiment of the present invention having an interactive start menu icon 320 or tray icon 340. In the exemplary embodiment, one or more of the icons 320, 340 has been “selected”, thereby providing the user with more detailed information. In the exemplary embodiment, attributes of program icon 410 have been altered to indicate the training is needed. Text may further accompany the attributes of the program icon to indicate more specific information. In the exemplary embodiment, the text “New Template Available” is present to indicate a new feature or an existing feature needs increased proficiency. This allows the user to quickly determine if the training would be beneficial. Similar icons may be used to support training for installed hardware. For example, attributes of hardware icon 420 have been altered to indicate to the user that a new lesson is available for a feature. The attributes may be altered based upon the rules set forth in the training tracking module 230. In the exemplary embodiment, hardware icon 420 provides lesson information regarding a video adapter. For example, if the computer detects multiple display devices attached to the computer, attributes of program icon 420 may be altered to inform the user of available lessons regarding multi-display support of the adapter.

In yet further embodiments of the invention, the program icons may visually indicate the amount of training needed to become proficient. For example, at least one attribute of program icon 430 is altered, for example shading, to indicate approximately 70% of the recommended lessons are completed or otherwise satisfied, such as through the user demonstrating proficiency, whereas at least one attribute of program icon 440 is altered to indicate approximately 90% of the lessons are completed. One skilled in the art will recognize that the shading may be accompanied by other altered attributes to indicate the training status to the user. Furthermore, the individual program icons 410-440 may be interactive to allow a user to “select” additional icons for further information.

The present invention has been described in terms of preferred and exemplary embodiments thereof. Numerous other embodiments, modifications and variations within the scope and spirit of the appended claims will occur to persons of ordinary skill in the art from a review of this disclosure.

We claim:

1. A computer implemented method of informing a user of the status of learning aspects of a computer application comprising the steps of:
(a) receiving a lesson list having at least one lesson from a memory, wherein the lesson comprises information relating to at least one feature of a computer application;
(b) receiving a user status list from a memory, wherein the status list comprises information regarding a user's completion status of the at least one lesson in the lesson list; and
(c) comparing the at least one lesson with the status list; and
(d) causing a display device to display at least one icon, wherein the icon comprises attributes to indicate the user's status of knowledge of at least one lesson.

2. The method of claim 1, wherein the attributes of at least one icon may be altered independently of the state of the computer application.

3. The method of claim 1, wherein at least one icon is selected from the group consisting of a program icon, a start menu icon or a task bar icon.

4. The method of claim 1, wherein at least one icon is a task bar icon.

5. The method of claim 1, wherein the icon attributes are selected from the group consisting of color, size, and shape.

6. The method of claim 1, wherein at least one icon is interactive.

7. The method of claim 6, further comprising the step of:
(e) upon selecting an interactive icon, displaying an output on a display device comprising information informing the user of at least one lesson configured to increase the user's knowledge of at least one feature.

8. The method of claim 7, wherein the output is configured to graphically display the percentage of completed lessons in at least one lesson list.

9. The method of claim 7, further comprising information informing the user of at least one new feature of at least one computer application.

10. The method of claim 1, further comprising the steps of:
(e) monitoring the use of at least one feature of at least one application by a user of a user computer; and
(f) comparing the use of the user computer to at least one rule to determine if the user has demonstrated proficiency in at least one feature of at least one lesson in the lesson list; and
(g) if the user has demonstrated proficiency in at least one feature, receiving an input by the status list indicating the user has completed at least one lesson.

11. The method of claim 10, wherein at least one rule to determine proficiency comprises at least one factor selected from the group consisting of the number of times a feature has been used, the total number of lessons available, repetition of the same error, repetition of the same class of error, the amount of time a feature is used, and the expected amount of time it would take a user to complete a beginning-to-end scenario.

12. The method of claim 11, further comprising the step of:
(h) if the user has not demonstrated proficiency in at least one feature, locking at least one program application until the user completes at least one lesson in the lesson list.

13. A computer implemented method of increasing the knowledge of a user of a user computer has regarding at least one hardware device comprising the steps of:
(a) detecting the presence of a hardware device installed on a user computer;
(b) receiving a lesson list comprising at least one lesson from a memory, wherein receiving the at least one lesson is determined by the detection of the hardware device;
(c) receiving a user status list from a memory, wherein the user status list comprises information regarding the user's completion of the at least one lesson in the lesson list;
(d) comparing the user status list with the at least one lesson; and
(e) causing a display device to display at least one icon, wherein the icon comprises attributes to indicate the user's status of knowledge regarding at least one lesson.

14. The method of claim 13, wherein the attributes of at least one icon may be altered independently of the state of the hardware device.

15. The method of claim 13, wherein at least one icon is selected from the group consisting of a program icon, a start menu icon or a task bar icon.

16. The method of claim 13, wherein at least one icon is a task bar icon.

17. The method of claim 13, wherein the icon attributes are selected from the group consisting of color, size, and shape.

18. The method of claim 13, wherein at least one icon is interactive.

19. A computer-readable medium having computer-executable instructions for performing steps comprising:
(a) searching a user computer for installed computer applications;
(b) comparing the installed applications with a list of a plurality of computer applications having at least one lesson;
(c) when an installed program matches a computer application on the memory, determining a match is found; and
(d) causing a display device to display at least one interactive icon, wherein the icon comprises attributes to indicate to the user at least one lesson is available.

20. The method of claim 19, wherein at least one interactive icon is a task bar icon.
